(19) United States
(12) Patent Application Publication
(10) Pub. No.: US 2025/0371764 A1
(43) Pub. Date: Dec. 4, 2025

(54) SYSTEMS AND METHODS FOR DYNAMICALLY CONFIGURING GRAPHICAL USER INTERFACE COMPONENTS BASED ON INTERFACE INTERACTION DATA

(71) Applicant: BANK OF AMERICA CORPORATION, CHARLOTTE, NC (US)

(72) Inventors: Karen Lea MacQueen, Lyndhurst, OH (US); Katherine Kei-Zen Dintenfass, Lincoln, RI (US); Jinna Kim, Charlotte, NC (US); Robert Nyeland Huggins, Charlotte, NC (US)

(73) Assignee: BANK OF AMERICA CORPORATION, CHARLOTTE, NC (US)

(21) Appl. No.: 18/732,914

(22) Filed: Jun. 4, 2024

(51) Int. Cl. G06T 11/60; G06F 9/451

(52) U.S. Cl. CPC G06T 11/60; G06F 9/451; G06T 2200/24

(57) ABSTRACT

Systems, computer program products, and methods are described herein for dynamically configuring graphical user interface components based on interface interaction data. The present invention is configured to identify a user device associated with a user account; identify at least one user access to a platform from the user device; determine, by an emotional artificial intelligence (AI) engine, at least one user platform preference for the user account, wherein the emotional AI engine is pre-trained on historical user platform preference data for the user account; generate, by the emotional AI engine, a user platform interface component based on the at least one user platform preference; and transmit the user platform interface component to the user device, wherein the transmission of the user platform interface component triggers a configuration of the GUI of the user device.

### FIELD OF THE INVENTION

The present invention embraces a system for dynamically configuring graphical user interface components based on interface interaction data.

### BACKGROUND

Issues often arise when users are viewing data and information across different user devices (such as over a graphical user interface on a mobile device as compared to a graphical user interface over a laptop or desktop) and the data is not dynamically configured based on past user preferences or the user's current ability to view the data. Such issues are further exacerbated when users have visual or hearing disabilities and cannot see or hear well. Further, and when a user is associated with a large network with multiple users and multiple types of preferences for viewing or rendering data, it can be difficult to dynamically generate such graphical user interfaces or renderings to accurately show the data to each user, especially without undue experimentation to determine what works and what doesn't work. Thus, a need exists for a system or method for dynamically configuring graphical user interface components based on interface interaction data in a secure, dynamic, and efficient manner.

Applicant has identified a number of deficiencies and problems associated with configuring graphical user interfaces based on interface interaction data. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for dynamically configuring and generating user interface components based on interface interaction data is provided. In some embodiments, the system may comprise: a processing device; a non-transitory storage device containing instructions when executed by the processing device, causes the processing device to perform the steps of: identify a user device associated with a user account; identify at least one user access to a platform from the user device; determine, by an emotional artificial intelligence (AI) engine, at least one user platform preference for the user account, wherein the emotional AI engine is pre-trained on historical user platform preference data for the user account; generate, by the emotional AI engine, a user platform interface component based on the at least one user platform preference; and transmit the user platform interface component to the user device, wherein the transmission of the user platform interface component triggers a configuration of the GUI of the user device.

In some embodiments, the at least one user platform preference comprises at least one data point mapped within the GUI of the user device. In some embodiments, the data point is a location identifier of a pixel within the GUI.

In some embodiments, the non-transitory storage device containing instructions when executed by the processing device, causes the processing device to perform the steps of: collect a first dataset of user platform preferences for the user account at a first instance, wherein the first dataset comprises rendering data of the graphical user interface of the user device; generate, based on the collection of the first dataset, a first training dataset for the emotional AI engine; collect a second dataset of user platform preferences for the user account at a second instance, wherein the second dataset comprises graphic data on the graphical user interface of the user device; generate, based on the collection of the second dataset, a second training dataset for the emotional AI engine; and train the emotional AI engine by applying the first training dataset and the second training dataset to the emotional AI engine.

In some embodiments, the at least one user platform preference comprises at least one of a sound preference, an image type preference, a location preference, a sound length preference, or a video type preference.

In some embodiments, the emotional AI engine is trained with at least one feedback for the at least one user platform preference as it is rendered in the user platform interface component.

In some embodiments, the non-transitory storage device containing instructions when executed by the processing device, causes the processing device to perform the steps of: identify, based on the user account, a user image; generate, by the emotional AI engine, a background image based on the at least one user platform preference; create a preference image by overlaying the user image onto the background image; generate a user image platform interface component based on the preference image; and transmit the user image platform interface component to the user device and cause a trigger of a configuration of the GUI of the user device with the user image platform interface component.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for dynamically configuring graphical user interface components based on interface interaction data, in accordance with an embodiment of the disclosure;

FIG. 2 illustrates an exemplary artificial intelligence (AI) engine subsystem architecture, in accordance with an embodiment of the disclosure;

FIG. 3 illustrates a process flow for dynamically configuring graphical user interface components based on interface interaction data, in accordance with an embodiment of the disclosure;

FIG. 4 illustrates a process flow for training an emotional AI engine, in accordance with an embodiment of the disclosure;

FIG. 5 illustrates a process flow for generating and transmitting the user image platform interface component to the user device, in accordance with an embodiment of the disclosure; and

FIG. 6 illustrates an exemplary technical component diagram for configuring a graphical user interface of a user device with a user platform preference based on a user platform interface component, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Issues often arise when users are viewing data and information across different user devices (such as over a graphical user interface on a mobile device as compared to a graphical user interface over a laptop or desktop) and the data is not dynamically configured based on past user preferences or the user's current ability to view the data. Such issues are further exacerbated when users have visual or hearing disabilities and cannot see or hear well. Further, and when a user is associated with a large network with multiple users and multiple types of preferences for viewing or rendering data, it can be difficult to dynamically generate such graphical user interfaces or renderings to accurately show the data to each user, especially without undue experimentation to determine what works and what doesn't work. Thus, a need exists for a system or method for dynamically configuring graphical user interface components based on interface interaction data in a secure, dynamic, and efficient manner.

Accordingly, the disclosure provides for the identification of a user device associated with a user account (a mobile device, a laptop, a desktop, a tablet, and/or the like); the identification of at least one user access to a platform (e.g., an application, a website, and/or the like) from the user device; and a determination, by an emotional artificial intelligence (AI) engine, of at least one user platform preference (e.g., such as a rendering preference of pixel-resolution, dimension preference of an image on the GUI, a position preference on the GUI, and/or the like) for the user account, wherein the emotional AI engine is pre-trained on historical user platform preference data for the user account. The disclosure further provides for the generation, by the emotional AI engine, of a user platform interface component (e.g., comprising preference data of the user) based on the at least one user platform preference; and the transmission of the user platform interface component to the user device, wherein the transmission of the user platform interface component triggers a configuration of the GUI of the user device.

In other words, the disclosure provides a mechanism for resolving at least the issues provided above, including where users are viewing information over different electronic communication methods (such as over a graphical user interface on a user device) and a user's preferences or learning styles are not considered. Further, and with the breadth of users associated with an entity's network, it may be extremely difficult to generate and configure these graphical user interfaces in a secure, dynamic, and efficient manner. Thus the disclosure leverages an emotional AI engine(s) to determine—based on current and historical user interaction data with their graphical user interface and with historical renderings via the graphical user interface/user device as a whole—user preferences for generating and configuring current and future renderings of information/data (such as advertisements, records, and/or the like). In some embodiments, and based on historical and current user interaction data, the disclosure may generate an image file (with no sound), an image with sound, a video, a sound recording, and/or the like to render the information in a user-preferred medium in real time. In some embodiments, the disclosure may additionally—when generating an image such as an advertisement—place the user's likeness within the image to show the user a computer-generated image of them interacting with the product of the advertisement. Thus, and in some such embodiments, the disclosure provides for using an emotional AI engine(s) trained on specific user historical and current interaction data with their user device and/or its graphical user interface, whereby the emotional AI engine may generate and configure the graphical user interface in real time to show user-preferred renderings of information.

What is more, the present invention provides a technical solution to a technical problem. As described herein, the technical problem includes the configuration of graphical user interfaces based on interface interaction data/user preference data. The technical solution presented herein allows for dynamically configuring graphical user interface components based on the interface interaction data, such that the configurations are done automatically, seamlessly, and in real or near real time. In particular, the disclosure is an improvement over existing solutions to the configuring GUIs automatically, (i) with fewer steps to achieve the solution, thus reducing the amount of computing resources, such as processing resources, storage resources, network resources, and/or the like, that are being used (e.g., by using an emotional AI engine trained on historical user interaction data/user preference data, which is further configured to generate user platform preferences, less manual coding and intervention must be done, which also reduces network traffic and processing); (ii) providing a more accurate solution to problem, thus reducing the number of resources required to remedy any errors made due to a less accurate solution (e.g., in some instances, and through real time or near real time feedback from users, the system may be configured to take real-time feedback data and generate new user platform interface components in near real time if they are not correct the first time); (iii) removing manual input and waste from the implementation of the solution, thus improving speed and efficiency of the process and conserving computing resources (e.g., through the use of automatic and dynamic solutions, less manual intervention and network cross communications must be done); (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

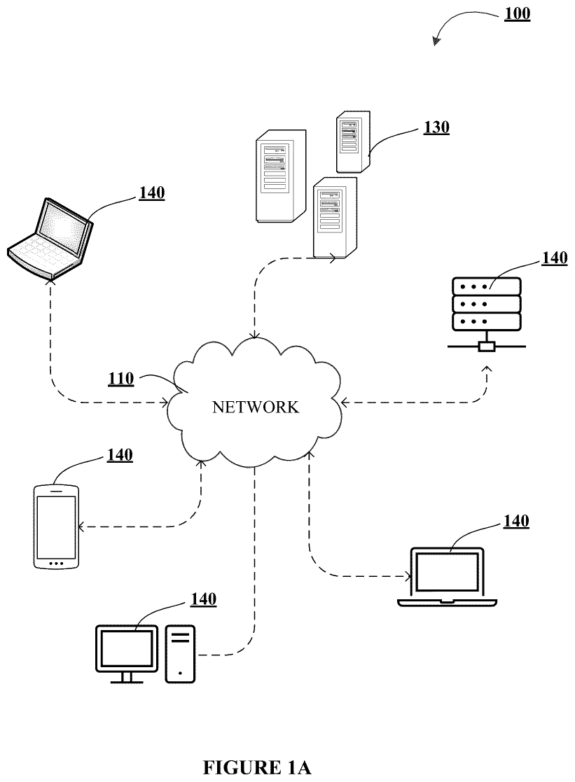

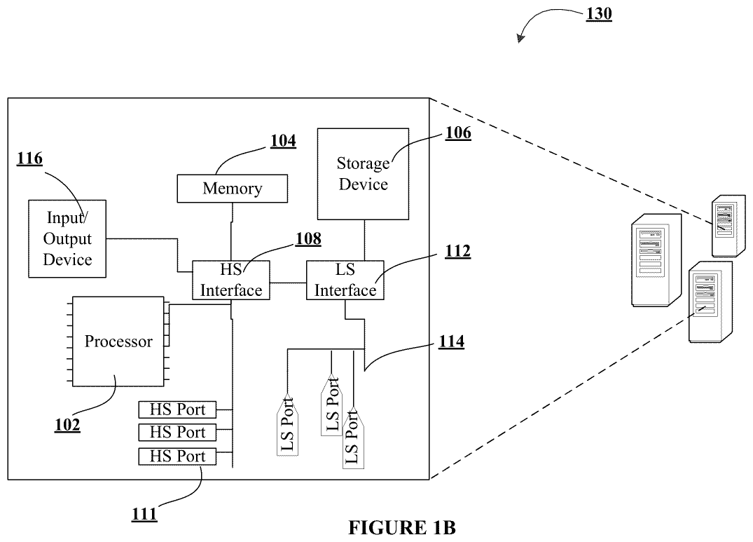

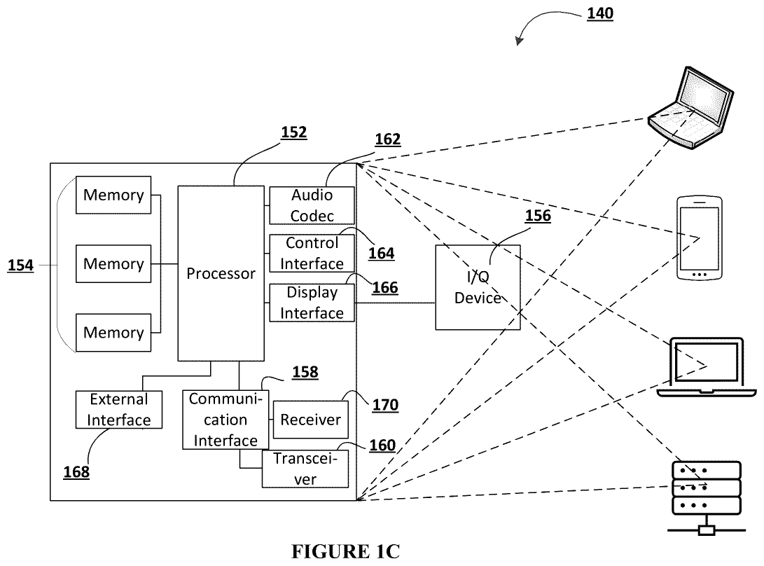

FIGS. 1A-1C illustrate technical components of an exemplary distributed computing environment for dynamically configuring graphical user interface components based on interface interaction data 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

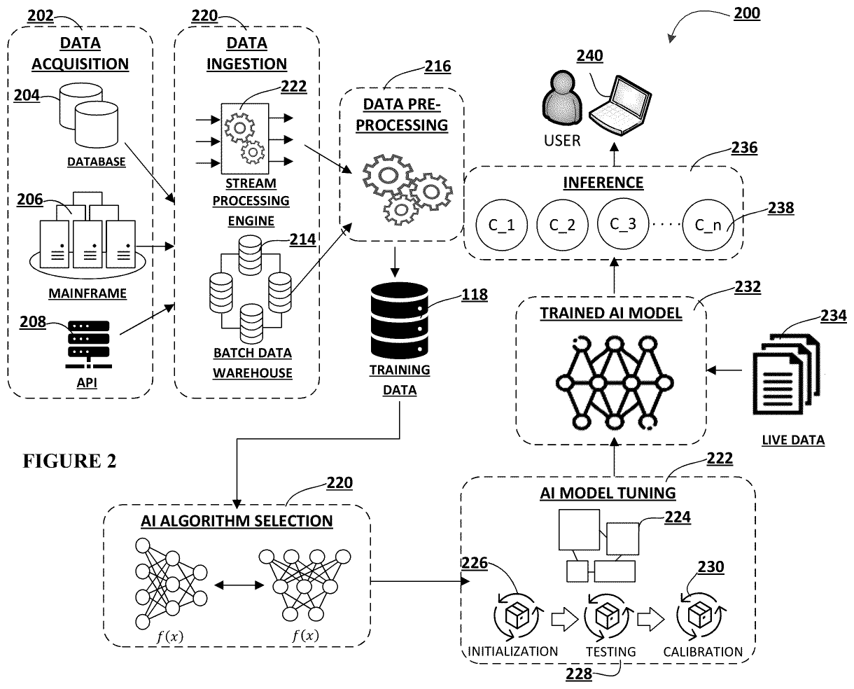

FIG. 2 illustrates an exemplary artificial intelligence (AI) engine subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

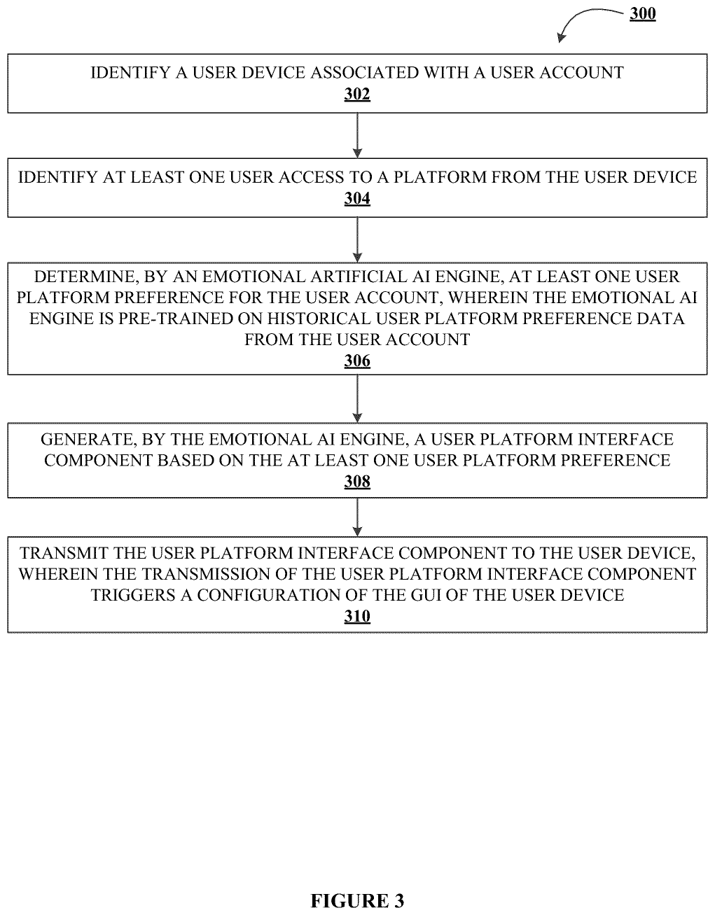

FIG. 3 illustrates a process flow 300 for dynamically configuring graphical user interface components based on interface interaction data, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, an artificial intelligence engine (e.g., such as the AI engine shown in FIG. 2) may perform some or all of the steps described in process flow 300.

As shown in block 302, the process flow 300 may include the step of identifying a user device associated with a user account. For example, the system may identify a user device that has accessed and/or is attempting to access a platform, a website, an email, an application, and/or the like, over a network. Additionally, and in some embodiments, the system may identify a user device once it's turned on and has access to a network, and thus, may access a platform, a website, an email, an application, and/or the like. In some embodiments, the user account may be identified based on authentication credentials received over the network from the user device and/or the user account may be identified based on the user device identifier itself (such as by a serial number, IMEI number, and/or the like), which may be linked with a particular user account. In some embodiments, the user account identified may be associated with, monitored, and/or controlled by an entity, such as a merchant, a financial institution, and/or the like, whereby the platform, website, application, and/or the like, accessed by the user device is associated with the particular platform, website, application, and/or the like.

As shown in block 304, the process flow 300 may include the step of identifying at least one user access to a platform from the user device. For example, the system may identify at least one user access to the platform, website, and/or application, from the user device, such as by the user device transmitting an API request to fetch data from a server associated with an entity of the platform, website, application, and/or the like. Additionally, and in some embodiments, the user device may store in its cache memory certain data of a platform, website, application, and/or the like, that has readily available and regularly accessed by the user device, such as a website or application's home page. As used herein, the term “platform” refers to an electronic tool for communication across a network, such as to access a website, an application, and/or the like, and which provides information or data from an entity's database (such as information regarding merchant offerings, resource accounts of the user, and/or the like) associated with the website, application, and/or the like.

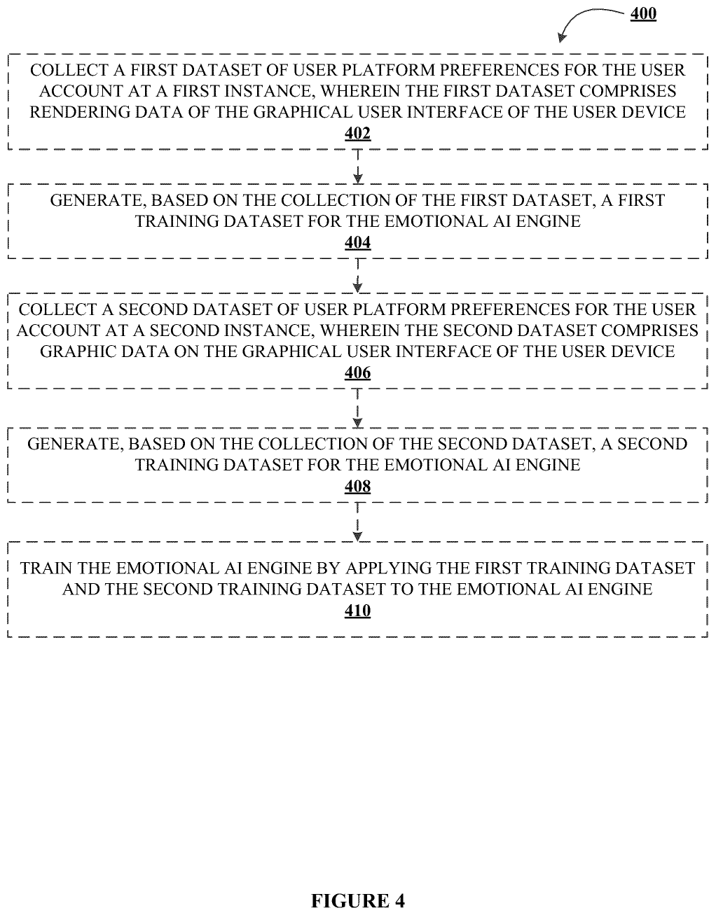

As shown in block 306, the process flow 300 may include the step of determining, by an emotional AI engine, at least one user platform preference for the user account, wherein the emotional AI engine is pre-trained on historical user platform preference data from the user account. For example, the system may determine, an emotional AI engine, which is trained and configured similar to that AI engine shown and described above with respect to FIG. 2, and which measures, understands, simulates, and reacts to a user's emotions as the user interacts with systems associated with the emotional AI engine (e.g., those systems and their data used as training data for the emotional AI engine), and which generates an output to effect a user's emotions (such as to improve it, stagnate it, lower it, and/or the like). Thus, the emotional AI engine described herein may be trained on data associated with at least the user account at issue (and/or other such user accounts associated with a same platform, entity, and/or the like), the user account's associated text, interface interaction data (such as how the user device is configured while interacting with the platform configured on the graphical user interface (GUI) of the user device), voice data, computer vision, physical characteristic data (such as eye movement as the user is viewing the configured GUI, and/or the like), and/or the like. Additionally and/or alternatively, the emotional AI engine may be trained with data, such as but not limited to rendering data (e.g., pixel preferences, location of pixels and/or of an image or graphic within the GUI, and/or the like) of the GUI of the user device, graphic data on the GUI of the user device, sound data (e.g., a type of sound for an alert, a decibel preference, a volume preference, a music preference, a voice or tone preference, and/or the like), and/or the like. Such training of the emotional AI engine is discussed in further detail below with respect to FIG. 4.

In some embodiments, the emotional AI engine is trained with at least one feedback for the at least one user platform preference as it is rendered in the user platform interface component. For example, the system may automatically generate a request for user input after the emotional AI engine has generated the user platform interface component (described in further detail below), whereby the request will ask for user feedback of the user platform interface component has it is shown on the user device. Such feedback may then be used by the emotional AI engine for further training and tuning to refine its determinations at future instances for the user or other such similar users.

Additionally, and based on the pre-training of the emotional AI engine, the emotional AI engine may be configured to determine at least one user platform preference for the user account. Such a user platform preference may comprise a preference of a graphic to configure on the GUI of the user device, a sound preference (e.g., a type of sound, a volume or decibel of sound, and/or the like), a location preference (a location within the GUI of the user device, such as the bottom left of the screen, the top-most portion of the screen, the bottom right of the screen, and/or the like), a sound length preference, a video type preference (e.g., a video showing a particular image or series of images, and/or the like), a rendering preference (e.g., a number of pixels, a color preference, a dimension preference on the GUI), and/or the like.

In some embodiments, the at least one user platform preference comprises at least one data point mapped within the GUI of the user device, wherein the data point is a location identifier of a pixel within the GUI. For example, the at least one user platform preference may comprise an identifier of a location of a pixel within a GUI, such that the preference may identify where in the user device's GUI the user platform interface component should be configured.

Additionally, the system may use past interface interaction data of the user device's GUI to determine what to render (e.g., photo, video, image, message, sound, and/or the like) in user platform interface component and where to render the user platform interface component in the GUI of the user device.

As shown in block 308, the process flow 300 may include the step of generating, by the emotional AI engine, a user platform interface component based on the at least one user platform preference. For example, the system may generate, by the emotional AI engine, a user platform interface component, which comprises a packet of data which can be read by a processor (such as a processor on a user device) and used to configure a GUI of a user device to render the data in a human-readable format. As used herein, the user platform interface component may configure the platform that the user device is accessing to show the data of user platform interface component (i.e., the data of the user platform preference) as a rendering on the user device GUI. Thus, and in some embodiments, the user platform preference may comprise a generated preferred image that the user of the user device would likely prefer; a generated preferred sound that the user would likely prefer; a generated position within the GUI that the user would likely prefer for viewing the platform and/or other such generated preferred images, videos, and/or the like; and/or the like. Thus, and as used herein, the user platform interface component comprises the data of the user platform preference, whereby once the user platform interface component is transmitted to a user device, the data of the user platform preference is rendered on the GUI of the user of the device and/or is rendered with the user device (such as where the user platform preference only comprises a sound).

As shown in block 310, the process flow 300 may include the step of transmitting the user platform interface component to the user device, wherein the transmission of the user platform interface component triggers a configuration of the GUI of the user device. Thus, and as described above, the system may automatically trigger a rendering of the user platform interface component (e.g., through the GUI, through a speaker on the user device, and/or the like) once the user platform interface component is transmitted to the user device. Such a trigger, in some embodiments, may only occur once the user device receives the user platform interface component.

FIG. 4 illustrates a process flow 400 for training an emotional AI engine, in accordance with an embodiment of the disclosure, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, an artificial intelligence engine (e.g., such as the AI engine shown in FIG. 2) may perform some or all of the steps described in process flow 400.

In some embodiments, and as shown in block 402, the process flow 400 may include the step of collecting a first dataset of user platform preferences for the user account at a first instance, wherein the first dataset comprises rendering data of the graphical user interface of the user device. For example, and in some embodiments, the system may collect at least one first dataset of user platform preferences, which may comprise a user's preferences of positioning within a GUI, dimensions of a GUI rendering, pixel-resolution, and/or the like. Additionally, and in some embodiments, the system may also collect dataset(s) for multiple users, which additionally comprise the same preferences as those listed above, but which may be used to generate a baseline of preferences across users. Such datasets may be collected at a first instance, at a second instance, and at later instances as they are generated. Additionally, and in some embodiments, physical characteristic data of the user may additionally be collected as the user interacts with their historical rendering data (e.g., pupil dilation, eye movement, mouse movement on the GUI of the user device, facial expression data, micro-expression data, and/or the like). Such data may be collected via at least one sensor on the user device, such as a camera of the user device, a microphone of the user device, and/or the like.

In some embodiments, and as shown in block 404, the process flow 400 may include the step of generating, based on the collection of the first dataset, a first training dataset for the emotional AI engine. For instance, and in such embodiments, the system may generate at least one first training dataset for the emotional AI engine based on the collected first training dataset, whereby the generated first training dataset comprises an ordered combination of the data of the collected first dataset, which may be organized based on a user account identifier, a user device identifier, and/or the like, type of user preference across multiple users (in order to generate a baseline for each preference type), and/or the like. In some such embodiments, the first training dataset may comprise all the graphical renderings and/or sound renderings historically used by the users and preferred by users based on their physical characteristic feedback being positive. Similarly, and in some embodiments, the system may additionally request such feedback in real time or near real time to transmitting the user platform interface component to the user device, and upon collecting the feedback from the user device, the system may automatically re-generate and transmit an updated user platform interface component to the user device (such as where the previous generation and transmission was determined to have an opposite effect than that intended by the emotional AI engine-such as a negative feedback). Such a process may be done iteratively and continuously until the intended reaction from the user is met and determined by the emotional AI engine.

In some embodiments, and as shown in block 406, the process flow 400 may include the step of collecting a second dataset of user platform preferences for the user account at a second instance, wherein the second dataset comprises graphic data on the graphical user interface of the user device. For instance, and in some embodiments, the system may collect a second dataset of user platform preferences comprising graphic data, which may further comprise a user's preference of images, videos, sounds, and/or the like, which are rendered on a GUI and/or via a user device (using a speaker). Additionally, and similar to the description provided above, the system may also collect dataset(s) for multiple users, which additionally comprise the same preferences as those listed above, but which may be used to generate a baseline of preferences across users. Such datasets may be collected at a first instance, at a second instance, and at later instances as they are generated. Additionally, and in some embodiments, physical characteristic data of the user may additionally be collected as the user interacts with their historical graphic data (e.g., pupil dilation, eye movement, mouse movement on the GUI of the user device, facial expression data, micro-expression data, and/or the like) as the user views or hears images/videos and sounds, respectively. Such data may be collected via at least one sensor on the user device, such as a camera of the user device, a microphone of the user device, and/or the like.

In some embodiments, and as shown in block 408, the process flow 400 may include the step of generating, based on the collection of the second dataset, a second training dataset for the emotional AI engine. Similar to the description provided above with respect to block 404, the system may also generate the second training dataset using the same methods as those provided above with respect to block 404, but with the second dataset.

As used and understood by persons of skill in the art herein, the training datasets for training the emotional AI engine are not limited to a first and second training dataset, and instead are intended only to describe an initial example of what may be used to train the emotional AI engine. Indeed, multiple training datasets may be generated from data collected at regular and frequent intervals, such as when the data is first created at a later instances than the first and second instances used herein. Thus, the emotional AI engine may continue to refine and tune itself as more data from a user or a plurality of users are collected.

In some embodiments, and as shown in block 410, the process flow 400 may include the step of training the emotional AI engine by applying the first training dataset and the second training dataset to the emotional AI engine. For example, and in some embodiments, the emotional AI engine may be trained by applying at least the first training dataset and the second training dataset to the emotional AI engine, whereby both training datasets (and those training datasets that may be generated at later instances) are used to refine and tune the AI engine to make predictions and generate future user platform preferences and user platform interface components.

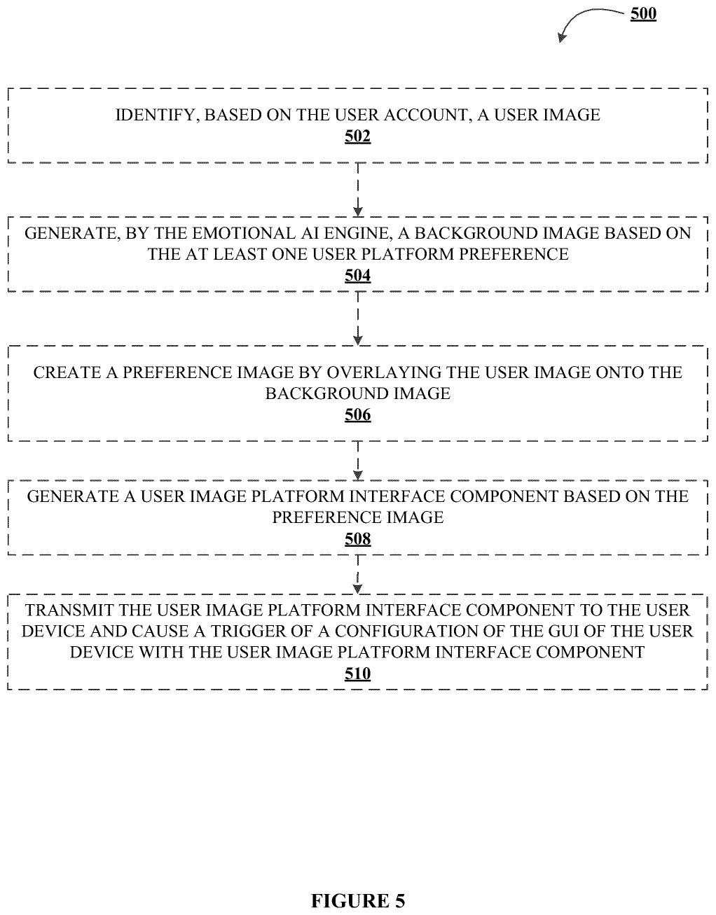

FIG. 5 illustrates a process flow 500 for generating and transmitting a user image platform to configure a graphical user interface of a user device, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an artificial intelligence engine (e.g., such as the AI engine shown in FIG. 2) may perform some or all of the steps described in process flow 500.

In some embodiments, and as shown in block 502, the process flow 500 may include the step of identifying, based on the user account, a user image. For example, the system may identify—based on the user account and any stored image data of the user—a user image. In some embodiments, the emotional AI engine (or another such AI engine trained to generate an image of the user, such as a generative AI engine) may generate its own image of the user. Such an image generation may be based on a combination of previous images of the user, based on physical characteristics known of the user, and/or the like. Such a user image (either identified or generated) may comprise background data that does not include the user's likeness (such as a building or portion of a building in the background, landscaping in the background, people in the background, and/or the like) and the AI engine (emotional AI engine, generative AI engine, AI engine, and/or the like) may be tasked with removing the background data of the image, such that only the outline and characteristics of the user is present.

In some embodiments, and as shown in block 504, the process flow 500 may include the step of generating, by the emotional AI engine, a background image based on the at least one user platform preference. For instance, the system may generate (such as by an emotional AI engine, generative AI engine, AI engine, and/or the like) a background image which is based on at least one user platform preference (such as a preferred video, image, sound, and/or the like). Additionally, and/or alternatively, the system may identify—using the emotional AI engine—an already generated or captured image as the background image, based on matching the user platform preference generated to the already generated or captured image. For example, and where a user's platform preference comprises a preference of animals, and more specifically puppies, the emotional AI engine may identify a captured image of a puppy as the background image. In some embodiments, the emotional AI engine may identify the background image by scanning an internet database, its own database(s), and/or the like. Similarly, and in the embodiments where the background image is generated, the system (using the emotional AI engine, the generative AI engine, and/or the like) may generate the background image based on combining a plurality of images identified from its own database(s), a client's database(s), an internet database, and/or the like.

In some embodiments, and as shown in block 506, the process flow 500 may include the step of creating a preference image overlaying the user image onto the background image. For example, the system may create a preference image which overlays the user image onto the background image, such that the likeness of the user appears to be interacting with the data and characteristics in the background image (e.g., a puppy based on the above example). In some embodiments, and based on rendering data preferred by the user, the preference image may be further configured to account for the user platform preference comprising rendering data (e.g., a preference of pixel-resolution, a preference of position in the GUI, a preference of dimensions, and/or the like).

In some embodiments, and as shown in block 508, the process flow 500 may include the step of generating a user image platform interface component based on the preference image. For example, the system may generate a user image platform interface component in a similar manner as that described above with respect to the user platform interface component, whereby the user image platform interface component comprises the data of the preference image, which may be used to render the user image on a user device after transmitting the user image platform interface component to the user device.

In some embodiments, and as shown in block 510, the process flow 500 may include the step of transmitting the user image platform interface component to the user device and cause a trigger of a configuration of the GUI of the user device with the user image platform interface component. For example, and as described briefly above, the system may transmit the user platform interface component to the user device, whereby upon transmitting the user platform interface component to the user device, the user platform interface component triggers the rendering of the GUI of the user device to be configured to show the preference image in a human-readable format. Thus, and used herein, the user of triggering any of GUIs with any of the interface components described herein allows for the automatic and near real time configuration of the GUI with the data of the interface components.

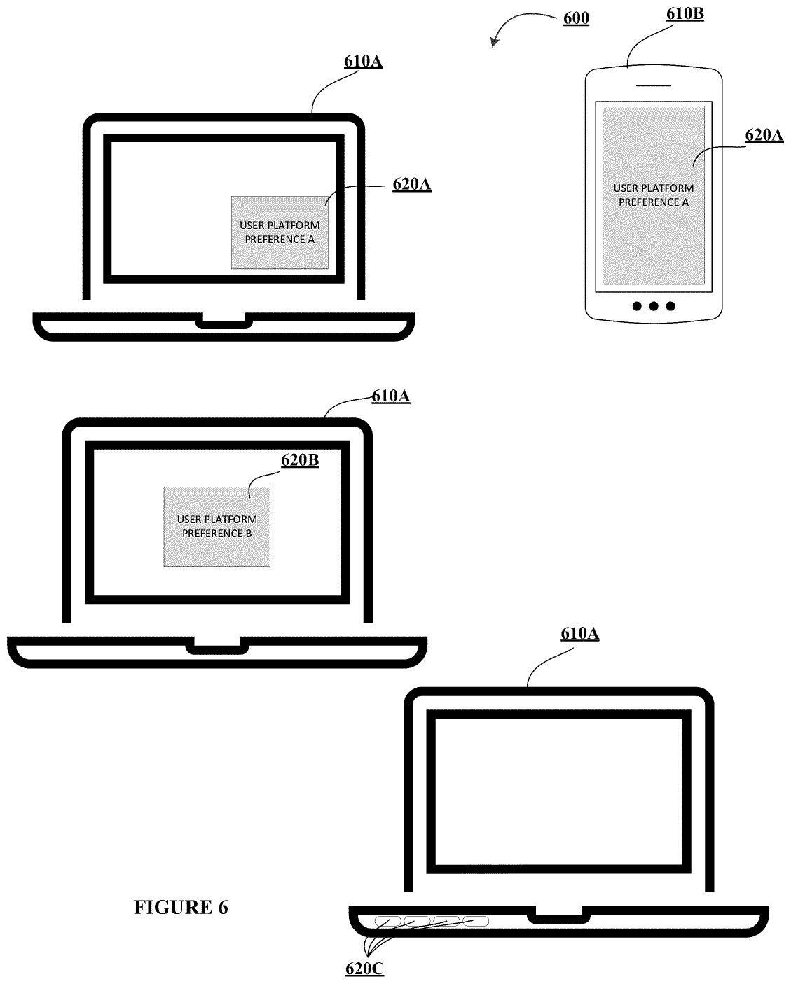

FIG. 6 illustrates an exemplary technical component diagram 600 for configuring a graphical user interface of a user device with a user platform preference based on a user platform interface component, in accordance with an embodiment of the disclosure. In some embodiments, a system (e.g., similar to one or more of the systems described herein with respect to FIGS. 1A-1C) may perform one or more of the steps of configuring the GUIs of exemplary technical component diagram 600. For example, a system (e.g., the system 130 described herein with respect to FIG. 1A-1C) may perform the steps configuring the GUIs of exemplary technical component diagram 600. In some embodiments, an artificial intelligence engine (e.g., such as the AI engine shown in FIG. 2) may perform some or all of the steps described in configuring the GUIs of exemplary technical component diagram 600.

For instance, and as shown in the technical diagram 600, a plurality of user devices (610A, 610B, and/or the like) are shown and each are configured with a user platform preference, which may differ in its rendering or presentation on each user device based on the underlying user platform preference data. For instance, and as shown in user device 610A (which comprises a laptop device), the user platform preference 620A may comprise an image, video, graphic, text data, and/or the like, which itself may have been generated by the emotional AI engine based on use preferences, but additionally, may have been configured in the GUI based on user preferences. For example, and as shown in user device 610A, the user platform preference A may only take up the right-most and bottom-most portion of the GUI, but in user device 610B which shows the same user platform preference A data, the user platform preference A is shown to take up the entire GUI of the mobile device. Thus, such a configuration of the user platform preference data may further be dynamically configured based on the user device accessing the platform.

Similarly, and with respect to other user platform preferences, the user device 610A may also configure the GUI to render different user platform preferences in different manners depending on the underlying data. For example, and where the user platform preference data comprises a video, a user may prefer (which has been determined by an emotional AI engine) that all videos are shown in the direct center of a laptop GUI, similar to that shown for user platform preference B 620B. Additionally, and as shown with a user platform preference which only comprises sound, the user device 610A may also only render the user platform preference via speakers 620C on the user device.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for dynamically configuring and generating user interface components based on interface interaction data, the system comprising:
a processing device;
a non-transitory storage device containing instructions when executed by the processing device, causes the processing device to perform the steps of:
identify a user device associated with a user account;
identify at least one user access to a platform from the user device;
determine, by an emotional artificial intelligence (AI) engine, at least one user platform preference for the user account, wherein the emotional AI engine is pre-trained on historical user platform preference data for the user account;
generate, by the emotional AI engine, a user platform interface component based on the at least one user platform preference; and
transmit the user platform interface component to the user device, wherein the transmission of the user platform interface component triggers a configuration of the GUI of the user device.

2. The system of claim 1, wherein the at least one user platform preference comprises at least one data point mapped within the GUI of the user device.

3. The system of claim 1, wherein the data point is a location identifier of a pixel within the GUI.

4. The system of claim 1, wherein the non-transitory storage device containing instructions when executed by the processing device, causes the processing device to perform the steps of:
collect a first dataset of user platform preferences for the user account at a first instance, wherein the first dataset comprises rendering data of the graphical user interface of the user device;
generate, based on the collection of the first dataset, a first training dataset for the emotional AI engine;
collect a second dataset of user platform preferences for the user account at a second instance, wherein the second dataset comprises graphic data on the graphical user interface of the user device;
generate, based on the collection of the second dataset, a second training dataset for the emotional AI engine; and
train the emotional AI engine by applying the first training dataset and the second training dataset to the emotional AI engine.

5. The system of claim 1, wherein the at least one user platform preference comprises at least one of a sound preference, an image type preference, a location preference, a sound length preference, or a video type preference.

6. The system of claim 1, wherein the emotional AI engine is trained with at least one feedback for the at least one user platform preference as it is rendered in the user platform interface component.

7. The system of claim 1, wherein the non-transitory storage device containing instructions when executed by the processing device, causes the processing device to perform the steps of:
identify, based on the user account, a user image;
generate, by the emotional AI engine, a background image based on the at least one user platform preference;
create a preference image by overlaying the user image onto the background image;
generate a user image platform interface component based on the preference image; and
transmit the user image platform interface component to the user device and cause a trigger of a configuration of the GUI of the user device with the user image platform interface component.

8. A computer program product for dynamically configuring and generating user interface components based on interface interaction data, the computer program product comprising a non-transitory computer-readable medium comprising code causing an apparatus to:
identify a user device associated with a user account;
identify at least one user access to a platform from the user device;
determine, by an emotional artificial intelligence (AI) engine, at least one user platform preference for the user account, wherein the emotional AI engine is pre-trained on historical user platform preference data for the user account;
generate, by the emotional AI engine, a user platform interface component based on the at least one user platform preference; and
transmit the user platform interface component to the user device, wherein the transmission of the user platform interface component triggers a configuration of the GUI of the user device.

9. The computer program product of claim 8, wherein the at least one user platform preference comprises at least one data point mapped within the GUI of the user device.

10. The computer program product of claim 9, wherein the data point is a location identifier of a pixel within the GUI.

11. The computer program product of claim 8, the computer program product further comprising non-transitory computer-readable medium comprising code causing an apparatus to:
collect a first dataset of user platform preferences for the user account at a first instance, wherein the first dataset comprises rendering data of the graphical user interface of the user device;
generate, based on the collection of the first dataset, a first training dataset for the emotional AI engine;
collect a second dataset of user platform preferences for the user account at a second instance, wherein the second dataset comprises graphic data on the graphical user interface of the user device;
generate, based on the collection of the second dataset, a second training dataset for the emotional AI engine; and
train the emotional AI engine by applying the first training dataset and the second training dataset to the emotional AI engine.

12. The computer program product of claim 8, wherein the at least one user platform preference comprises at least one of a sound preference, an image type preference, a location preference, a sound length preference, or a video type preference.

13. The computer program product of claim 8, wherein the emotional AI engine is trained with at least one feedback for the at least one user platform preference as it is rendered in the user platform interface component.

14. The computer program product of claim 8, the computer program product further comprising non-transitory computer-readable medium comprising code causing an apparatus to:
identify, based on the user account, a user image;
generate, by the emotional AI engine, a background image based on the at least one user platform preference;
create a preference image by overlaying the user image onto the background image;
generate a user image platform interface component based on the preference image; and
transmit the user image platform interface component to the user device and cause a trigger of a configuration of the GUI of the user device with the user image platform interface component.

15. A computer implemented method for dynamically configuring and generating user interface components based on interface interaction data, the computer implemented method comprising:
identifying a user device associated with a user account;
identifying at least one user access to a platform from the user device;
determining, by an emotional artificial intelligence (AI) engine, at least one user platform preference for the user account, wherein the emotional AI engine is pre-trained on historical user platform preference data for the user account;
generating, by the emotional AI engine, a user platform interface component based on the at least one user platform preference; and
transmitting the user platform interface component to the user device, wherein the transmission of the user platform interface component triggers a configuration of the GUI of the user device.

16. The computer implemented method of claim 15, wherein the at least one user platform preference comprises at least one data point mapped within the GUI of the user device.

17. The computer implemented method of claim 16, wherein the data point is a location identifier of a pixel within the GUI.

18. The computer implemented method of claim 15, wherein the at least one user platform preference comprises at least one of a sound preference, an image type preference, a location preference, a sound length preference, or a video type preference.

19. The computer implemented method of claim 15, wherein the emotional AI engine is trained with at least one feedback for the at least one user platform preference as it is rendered in the user platform interface component.

20. The computer implemented method of claim 15, further comprising:
identifying, based on the user account, a user image;
generating, by the emotional AI engine, a background image based on the at least one user platform preference;
creating a preference image by overlaying the user image onto the background image;
generating a user image platform interface component based on the preference image; and
transmitting the user image platform interface component to the user device and cause a trigger of a configuration of the GUI of the user device with the user image platform interface component.
